(19) United States
(12) Patent Application Publication
(10) Pub. No.: US 2021/0214065 A1
(43) Pub. Date: Jul. 15, 2021

(54) AIRCRAFT PRESSURIZED CABIN DOOR WITH A STRUCTURE FORMED BY BEAMS

(71) Applicant: LATECOERE, Toulouse Occitaine (FR)

(72) Inventor: Sabastien DEVILLEZ, SAINT JEAN (FR)

(73) Assignee: LATECOERE, Toulouse Occitaine (FR)

(21) Appl. No.: 15/733,979

(22) PCT Filed: May 28, 2019
(86) PCT No.: PCT/EP2019/063846

§ 371 Date: Dec. 1, 2020

(30) Foreign Application Priority Data
Jun. 2, 2018 (FR) 1854805

(51) Int. Cl. B64C 1/14; B64C 1/12

(52) U.S. Cl. CPC B64C 1/1461; B64C 2001/0072; B64C 1/12

(57) ABSTRACT

Aircraft pressurized cabin door (1) including an outer panel (2) and a door structure (3). The door structure (3) includes two circumferential beams (4) fastened to the lateral edges of the door (1); a plurality of longitudinal beams (5) arranged substantially perpendicularly between the circumferential beams (4) and fastened to the outer panel (2), each longitudinal beam (5) extending from one circumferential beam (4) to the other. Each longitudinal beam (5) is an open profile of which the opening (18) is directed toward the outer panel (2), this opening (18) being closed by the internal face of the outer panel (2) to which the longitudinal beam (5) is fastened. Each beam includes a structural redundancy element.

### CROSS REFERENCE TO RELATED APPLICATION

This application is a national stage entry of PCT/EP2019/063846 filed May 28, 2019, under the International Convention and claiming priority over French Patent Application No. 1854805 filed Jun. 2, 2018.

### TECHNICAL FIELD

The invention concerns the aeronautical sector and relates to an aircraft pressurized cabin door.

Aircraft, and in particular airplanes, are generally equipped with doors allowing people and equipment to enter and exit the cabin. Since the cabin is pressurized, these doors must ensure, during flight, the closure of the cabin and the maintenance of a high-pressure difference between the interior of the cabin and the exterior. For this purpose, the pressurized cabin doors comprise an outer panel, also referred to as the “skin”, which, when the door is closed, is placed in the continuity of the fuselage of the aircraft and which acts as a barrier for the maintenance of the pressure difference. In order for this outer panel to be able to have an acceptable thickness in spite of the high stresses due to the pressure difference, the door also comprises a door structure formed by beams fastened to the outer panel to ensure the rigidity thereof.

Moreover, the cabin doors also generally serve as a support for various equipment such as door opening mechanisms or comfort and safety equipment. In addition to ensuring the rigidity of the door, the door structure must also be designed to bear these additional masses.

Pressurized cabin doors are a critical safety element of an aircraft since they are guarantors of the pressure being maintained inside the cabin. The door panels and the associated door structures are therefore designed for a high level of safety.

### PRIOR ART

Patent application FR2928620 describes an airplane cabin door of which the door structure comprises transverse beams and longitudinal members which cross one another to form a rigid structure. The transverse beams and the longitudinal members are IPN-type profiles. In the example described by that document, four longitudinal members and six transverse beams cross one another at a right angle and are fastened to one another, thus forming a structure with a high degree of rigidity.

Such a door structure is difficult and costly to manufacture, by virtue in particular of the connections to be produced at the crossings between the longitudinal members and the transverse beams. The connections require fastenings, additional parts or complex connections and also entail increases in mass.

Moreover, the crossing between the transverse beams and the longitudinal members makes it difficult to manufacture this door from composite materials for which the production of such intersections generates an additional difficulty in terms of assembly or molding.

Patent application U.S. 2007007390 proposes resolving some of the disadvantages indicated above by proposing a monolithic aircraft door produced in one piece. Strong reinforcing ribs cross one another at a right angle over the whole internal surface of the door. Such a door also has a substantial degree of rigidity suitable for its use in aeronautics, but is highly complex and costly to produce. Its mass is also substantial.

Patent application U.S. 2009/0078826 describes a pressurized cabin door made of composite materials and having a design optimized for the use of these composite materials. The door comprises beams which are arranged at a right angle to one another but which do not cross one another. The manufacturing method for such a door is simplified in relation to the above-stated methods and the production from composite materials is facilitated. However, the support of the skin of such a door is less than that of the crossed-beam door structures.

### SUMMARY OF THE INVENTION

The invention aims to improve the aircraft pressurized cabin doors by proposing such a door which combines a high degree of rigidity allowing its use for aircraft flying at altitude with a simplicity in terms of production which allows quick and low-cost manufacture and which allows its production using any method and materials, including composite materials.

Accordingly, the invention is aimed at an aircraft pressurized cabin door comprising an outer panel and a door structure. The door structure includes:

two circumferential beams fastened to the lateral edges of the door;

a plurality of longitudinal beams arranged substantially perpendicularly between the circumferential beams and fastened to the outer panel, each longitudinal beam extending from one circumferential beam to the other.

Each longitudinal beam is an open profile of which the opening is directed toward the outer panel, this opening being closed by the internal face of the outer panel to which the longitudinal beam is fastened.

The pressurized cabin door may comprise the following additional features, alone or in combination:

a longitudinal beam has two bearing bars fastened to the outer panel, these bearing bars extending over the whole length of the longitudinal beam, on either side of said opening;

the longitudinal beam comprises two lateral walls extending obliquely toward one another from the two bearing bars;

each bearing bar is formed by a fold of one of the lateral walls;

the longitudinal beam comprises a top wall, opposed to the bearing bars, of which the width, measured in a plane perpendicular to the longitudinal axis of the longitudinal beam, is less than or equal to the distance separating the two bearing bars;

a longitudinal beam comprises a load redundancy rib extending longitudinally inside the longitudinal beam over the whole length of the longitudinal beam;

the load redundancy rib is formed by a planar redundancy wall;

the load redundancy rib comprises fastening legs for fastening the planar redundancy wall to the longitudinal beam;

the load redundancy rib is formed by a tube;

the longitudinal beam is formed by three separate parts forming a load redundancy wall;

the door structure comprises a frame formed by the circumferential beams and by two longitudinal beams situated at the ends of the circumferential beams;

the longitudinal beams are fastened, by each of their ends, to the circumferential beams;

the circumferential beams comprise a web formed by a single wall;

a circumferential beam comprises a fastening flange fastened to the outer panel and formed by a fold of the web of the circumferential beam;

the circumferential beams comprise reinforcing flanges opposed to the outer panel;

the reinforcing flanges are fastened to the longitudinal beams;

the reinforcing flange of a circumferential beam is formed by a fold of the web of this circumferential beam;

the door comprises at least one circumferential support extending between two longitudinal beams;

the door comprises at least one porthole between two longitudinal beams.

In the present description and in the claims, the adjective “longitudinal” refers to the longitudinal direction of the fuselage of the aircraft. The longitudinal beams are therefore beams extending over the door parallel to the longitudinal axis in which the fuselage of the aircraft extends. Likewise, the adjective “circumferential” refers to the circumference of the fuselage of the aircraft. The circumferential beams are therefore beams which extend along a circle relative to a section of the fuselage of the aircraft. Likewise, the internal face of the outer panel designates the face which is on the cabin side, as opposed to the external face of the outer panel which is directed toward the exterior.

Such a door ensures its rigidity without having recourse to beams which cross one another. The beams, which are arranged transversely to one another, come into contact, the ends of one beam against the flank of another beam, without crossing. The junctions between beams are thus simplified, and the assembly of beams produced beforehand is simplified. This arrangement is particularly conducive for production using composite materials.

The invention makes it possible moreover to employ a number of manufacturing techniques, various materials and techniques for implementation which can be used for the same door. The simplicity of the design makes it possible to efficiently implement the majority of the techniques used in aeronautical construction and to envision technologies which are too complex for a crossed-beam structure.

In spite of its assembly simplicity, the door has a high degree of rigidity allowing the outer panel to maintain large differences in pressure between the interior and the exterior of the cabin.

Each of the longitudinal beams has two bearing lines, on either side of the opening of its profile, for the fastening of the outer panel. A longitudinal beam provides two parallel and spaced-apart securing regions for the whole width of the outer panel.

### PRESENTATION OF THE DRAWINGS

Other features and advantages of the invention will become apparent on reading the following nonlimiting description with reference to the appended drawings, in which:

FIG. 1 is a perspective view of the internal face of a pressurized cabin door according to the invention;

FIG. 2 is a view in vertical section of the door of FIG. 1;

FIG. 3 is an enlarged partial view of FIG. 2, illustrating a first embodiment of a longitudinal beam;

FIGS. 4 to 7 respectively illustrate a second, third and fourth embodiment of a longitudinal beam;

FIG. 8 is a partial view of FIG. 2 illustrating the behavior of the door under the effect of pressure;

FIG. 9 illustrates a variant of the door of FIG. 1.

### DETAILED DESCRIPTION

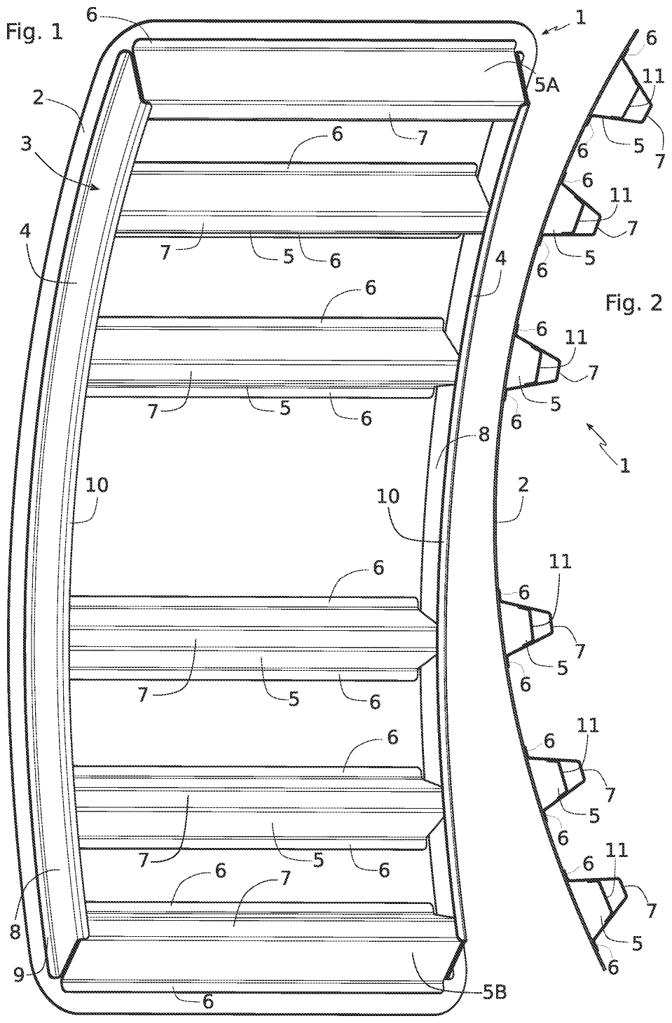

FIG. 1 illustrates in perspective an aircraft pressurized cabin door 1. In the present example, this door 1 is intended to close a corresponding opening made in the fuselage of an airplane. The door 1 can open when the airplane is on the ground to allow passengers to enter and exit, to constitute an emergency exit, an access hatch to the hold, or any other opening panel for an aircraft. The cabin door 1 is combined in a conventional manner with hinge mechanisms and opening and closing control mechanisms and also with sealing devices (not shown).

The cabin door 1 comprises an outer panel 2 and a door structure 3 which reinforces the strength of the outer panel 2. When the cabin door 1 is closed, the outer panel 2 constitutes the external surface of the airplane, in the continuation of the fuselage. The outer panel 2 can be produced for example from an aluminum sheet having a thickness of 2 to 5 millimeters. In the present example, the outer panel 2 has a curvature (see FIG. 2) which follows the shape of the fuselage of the airplane, the cross section of which is generally substantially circular.

The door structure 3 is fastened to the internal portion of the outer panel 2, that is to say on the interior side of the cabin of the airplane. The door structure 3 comprises two circumferential beams 4 which are fastened to the outer panel 2 on the lateral edges of the door 1. The circumferential beams 4 follow the circumferential curvature of the outer panel 2, and more generally of the fuselage of the airplane. In the example described, the circumferential beams 4 are vertical beams (with reference to the position depicted in FIG. 1), each being fastened in the vicinity of a lateral edge of the outer panel 2.

The door structure 3 also comprises a plurality of longitudinal beams 5 which extend in the longitudinal direction of the fuselage of the airplane, that is to say, with reference to the position of FIG. 1, substantially horizontally. Each longitudinal beam 5 comprises a first end coming into contact with one of the circumferential beams 4, and comprises a second end which comes into contact with the other circumferential beam 4. Each longitudinal beam 5 thus extends perpendicularly to the circumferential beams 4, from one circumferential beam 4 to the other. In a variant, each longitudinal beam 5 extends simply transversely to the circumferential beams 4; in certain cases, the door 1 is mounted in evolving regions or the longitudinal beams are not perpendicular to the circumferential beams.

The longitudinal beams 5 are profiles each having two bearing bars 6 which are fastened to the outer panel 2 across the whole length of the corresponding longitudinal beam 5. Each of the longitudinal beams 5 comprises a top wall 7, opposed to the bearing bars 6. In the example of FIGS. 1 and 2, the top wall 7 is planar.

The circumferential beams 4 each comprise a web 8 formed by a single wall extending perpendicularly to the surface of the outer panel 2. Each circumferential beam 4 additionally comprises a fastening flange 9 for fastening it to the outer panel 2, and a reinforcing flange 10 which can be fastened to the top wall 7 of each longitudinal beam 5 which comes into contact with the circumferential beam 4 in question.

The fastening flange 9 and the reinforcing flange 10 can be formed by folds of the web of the circumferential beam 4.

The two circumferential beams 4 and the two upper-end and lower-end longitudinal beams 5A, 5B of the door 1 constitute a frame of the door structure 3. Each of the ends of the web 8 of the circumferential beams 4 is fastened to the corresponding longitudinal end beam 5A, 5B.

FIG. 2 is a vertical section of the door 1 of FIG. 1 and shows the profile of the longitudinal beams 5 and also the arrangement thereof with respect to the outer panel 2. Each longitudinal beam 5 is fastened to the outer panel 2 by its two bearing bars 6 such that its top wall 7 is substantially parallel to that portion of the outer panel 2 situated between the two bearing bars 6.

The longitudinal beams 5 are open trapezoidal profiles of which the opening 18 is directed toward the outer panel 2. In other words, the longitudinal beams 5 are cylinders of which the directrix curve is a trapezoidal shape which is open at the large side of the trapezoid. The opening 18 is closed by the internal face of the outer panel 2 to which the corresponding longitudinal beam (5) is fastened.

The fastening of the bearing bars 6 to the outer panel 2 closes the opening 18 of the longitudinal beam 5, with the result that the latter constitutes a hollow shape of which the interior is not accessible.

Since the profile of the longitudinal beams 5 is trapezoidal, the width of the top wall 7, measured in a plane perpendicular to the longitudinal axis of the longitudinal beam 5, is less than the distance separating the two bearing bars 6.

Each longitudinal beam 5 additionally comprises a load redundancy rib 11.

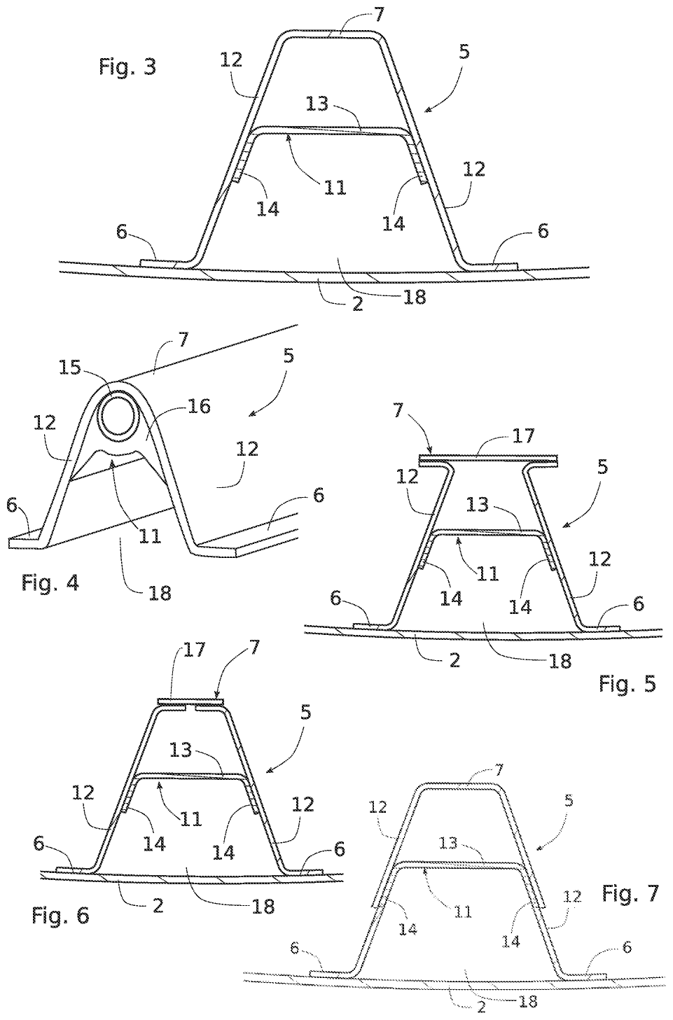

FIG. 3 is an enlarged view of FIG. 2, showing the profile of one of the longitudinal beams 5. The longitudinal beam 5 is here produced in two parts, for example from folded sheets, from metals or from composite materials shaped by extrusion or by molding.

A first part includes the two bearing bars 6, two lateral walls 12 extending obliquely toward one another and, between these two lateral walls 12, the top wall 7. The bearing bars 6 are each formed by a fold of a lateral wall 12.

The second part constituting the longitudinal beam 5 comprises a planar redundancy wall 13 and fastening legs 14 for fastening it to the first part. The load redundancy rib 11 extends over the whole length of the longitudinal beam 5.

FIGS. 4 to 7 illustrate four variants for the profile of the longitudinal beams 5. Similar elements of the various variants bear the same reference numbers in the figures.

FIG. 4 represents in perspective the end of a longitudinal beam 5. The top wall 7 is here rounded.

The load redundancy rib 11 is here formed by a tube 15 of circular cross section extending inside the longitudinal beam 5 over the whole length thereof. The tube 15 is retained against the top wall 7 by a retaining part 16.

The variant of FIG. 5 is illustrated according to a section similar to the section of FIG. 3. According to this variant, the top wall 7 is a bar 17 extending over the whole length of the longitudinal beam 5 and fastened to a portion of the lateral walls 12 which are curved outwardly. With suitable dimensioning, this bar 17 can provide a load redundancy function in place of the redundancy wall 13, which can thus be optionally omitted.

The variant of FIG. 6 relates, for its part, to another shape of the top wall 7, which is likewise formed by a bar 17 fastened here to portions of the lateral walls 12 which are curved inwardly. With suitable dimensioning, this bar 17 can provide a load redundancy function in place of the redundancy wall 13, which can thus be optionally omitted.

The variant of FIG. 7 is illustrated according to a section similar to that of FIG. 3. According to this variant, the longitudinal beam 5 is likewise produced in two parts.

A first part includes the two bearing bars 6, two lateral walls 12 extending obliquely toward one another and, between these two lateral walls 12, the redundancy wall 13.

The bearing bars 6 are each formed by a fold of a lateral wall 12. The second part constituting the longitudinal beam 5 also comprises two lateral walls 12 extending obliquely toward one another and, between these two lateral walls 12, the top wall 7.

Fastening legs 14 allow the fastening of the two parts. The load redundancy rib 11 extends over the whole length of the longitudinal beam 5.

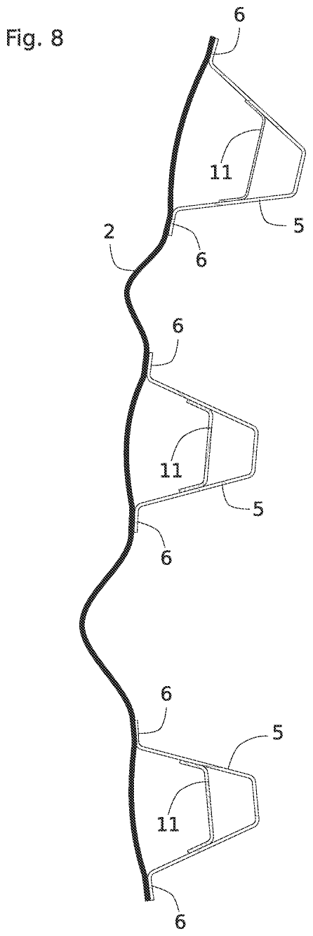

FIG. 8 is an enlarged view of a portion of FIG. 2 showing three longitudinal beams 5 viewed in section and a corresponding portion of the outer panel 2. In this FIG. 8, the deformations of the outer panel 2 due to the pressure have been greatly exaggerated for the needs of the description. Specifically, since the cabin door 1 is intended to close the fuselage of an airplane in flight, the outer panel 2 is a skin having to contain a high-pressure difference between the interior of the cabin and the exterior. The pressure exerted on the internal face of the outer panel 2 deforms it toward the exterior. FIG. 8 shows that, between two longitudinal beams 5, the deformation takes the form of a fold toward the exterior. It is therefore necessary to provide sufficient longitudinal beams 5 in accordance with the height of the door such that these deformations appearing between the longitudinal beams 5 are contained within an acceptable range.

Moreover, with regard to each longitudinal beam 5, a weaker deformation takes place between the two bearing bars 6 of one and the same longitudinal beam 5. A lightweight high-performance reinforcement is thus obtained for each longitudinal beam 5.

The load redundancy rib 11 contributes moreover to this maintenance of a weak deformation of the outer panel 2 between the two bearing bars 6.

Moreover, the load redundancy rib 11 performs another function associated with safety. During the bending work of the longitudinal beams 5 (from the interior of the cabin toward the exterior), the top wall 7 is stressed in compression. Now, the top wall 7 can be deteriorated for an accidental reason or an undetected fault. If, in an extreme case, this deterioration leads to the breakage of the top wall 7, the load redundancy rib 11 then provides the same function as the top wall 7 and maintains the integrity of the longitudinal beam 5 in question. The bending work from the interior of the cabin toward the exterior, which is the main work of the longitudinal beams 5, is thus secured by a double mechanical path of load transmission. The redundancy provided by the load redundancy rib 11 contributes to the operational security of the cabin door 1, which is a vital safety element of the airplane since any degradation of the pressure barrier formed by the door 1 is critical.

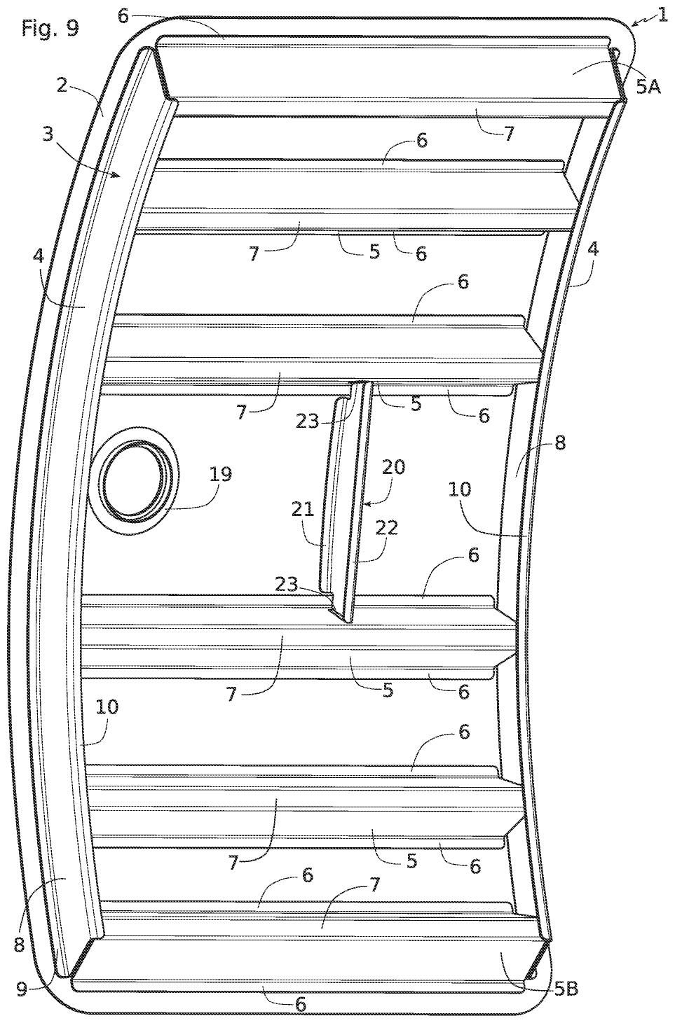

FIG. 9 illustrates a variant embodiment of the cabin door. The structure of the door is the same as FIG. 1 and the common elements bear the same numbers in the figures. According to this variant, the door 1 additionally comprises a porthole 19 between the two circumferential beams 4 and between the two longitudinal beams 5. The arrangement of the beams 4, 5 allows a high degree of freedom in the horizontal positioning of the porthole 19.

In FIG. 9, the cabin door also comprises a circumferential support 20 installed between two longitudinal beams 5 and making it possible to support mechanisms associated with the door or to provide an additional local support for the outer panel 2. The circumferential support 20 can comprise:

fastening legs 21 hugging the shape of the outer panel 2 and being able to be fastened thereto;

a reinforcing fold 22 generating the inertia and the stability of the circumferential support;

one or more fastening legs 23 for fastening the support 20 to the longitudinal beams 5.

Other variant embodiments of the pressurized cabin door 1 can be implemented without departing from the scope of the invention. For example, the fastening of the circumferential beams 4 and of the longitudinal beams 5 to the outer panel 2 can be realized by any means such as: mechanical fastening (screw, rivet, clamp, etc.), welding, adhesive bonding or any other means. The same equally applies to the fastening between the longitudinal beams 5 and the circumferential beams 4, and also between the various parts making up the longitudinal beams 5.

Moreover, the various embodiments and variants described can be combined within one and the same door.

1. An aircraft pressurized cabin door (1) comprising:
an outer panel (2); and
a door structure (3),
wherein the door structure (3) comprises:
two circumferential beams (4) fastened to lateral edges of the door (1);
a plurality of longitudinal beams (5) arranged perpendicularly between the circumferential beams (4) and fastened to the outer panel (2), each longitudinal beam (5) extending from one circumferential beam (4) to the other;
and in that each longitudinal beam (5) is an open profile of which the opening (18) is directed toward the outer panel (2), the opening (18) being closed by the internal face of the outer panel (2) to which the longitudinal beam (5) is fastened.

2. The door as claimed in claim 1, wherein the longitudinal beam (5) has two bearing bars (6) fastened to the outer panel (2), the bearing bars (6) extending over the whole length of the longitudinal beam (5), on either side of said opening (18).

3. The door as claimed in claim 2, wherein the longitudinal beam (5) comprises two lateral walls (12) extending obliquely toward one another from the two bearing bars (6).

4. The door as claimed in claim 3, wherein each bearing bar (6) is formed by a fold of one of the lateral walls (12).

5. The door as claimed in claim 2, wherein the longitudinal beam (5) comprises a top wall (7), opposed to the bearing bars (6), of which the width, measured in a plane perpendicular to the longitudinal axis of the longitudinal beam (5), is less than or equal to the distance separating the two bearing bars (6).

6. The door as claimed in claim 1, wherein the longitudinal beam (5) comprises a load redundancy rib (11) extending longitudinally inside the longitudinal beam (5) over the whole length of the longitudinal beam (5).

7. The door as claimed in claim 6, wherein the load redundancy rib (11) is formed by a planar redundancy wall (13).

8. The door as claimed in claim 7, wherein the load redundancy rib (11) comprises fastening legs (14) for fastening the planar redundancy wall (13) to the longitudinal beam (5).

9. The door as claimed in claim 6, wherein the load redundancy rib (11) is formed by a tube (15).

10. The door as claimed in claim 2, wherein the longitudinal beam is formed by three separate parts forming a load redundancy wall.

11. The door as claimed in claim 1, wherein the door structure (3) comprises a frame formed by the circumferential beams (4) and by two longitudinal beams (5) situated at the ends of the circumferential beams (4).

12. The door as claimed in claim 1, wherein the longitudinal beams (5) are fastened, by each of their ends, to the circumferential beams (4).

13. The door as claimed in claim 1, wherein the circumferential beams (4) comprise a web (8) formed by a single wall.

14. The door as claimed in claim 13, wherein the circumferential beam (4) comprises a fastening flange (9) fastened to the outer panel (2) and formed by a fold of the web (8) of the circumferential beam (4).

15. The door as claimed in claim 1, wherein the circumferential beams (4) comprise reinforcing flanges (10) opposed to the outer panel (2).

16. The door as claimed in claim 15, wherein the reinforcing flanges (10) are fastened to the longitudinal beams (5).

17. The door as claimed in claim 15, wherein the reinforcing flange (10) of the circumferential beam (4) is formed by a fold of the web (8) of the circumferential beam (4).

18. The door as claimed in claim 1, further comprising at least one circumferential support extending between two longitudinal beams (5).

19. The door as claimed in claim 1, further comprising at least one porthole between two longitudinal beams (5).
